(19) United States
(12) Patent Application Publication
(10) Pub. No.: US 2013/0125445 A1
(43) Pub. Date: May 23, 2013

(54) Pivoting Ice Fishing Rod Support

(71) Applicant: EZ Fisherman, LLC, Rubicon, WI (US)

(72) Inventors: Kevin Schmitt, Rubicon, WI (US); Jeff Steier, Lomira, WI (US)

(73) Assignee: EZ Fisherman, LLC, Rubicon, WI (US)

(21) Appl. No.: 13/680,816

(22) Filed: Nov. 19, 2012

Related U.S. Application Data
(60) Provisional application No. 61/563,136, filed on Nov. 23, 2011.

(51) Int. Cl. A01K 97/01; A01K 97/10

(52) U.S. Cl. CPC A01K 97/01; A01K 97/10
USPC 43/4.5; 43/21.2

(57) ABSTRACT

An ice fishing device is provided by the present disclosure including a collapsible elevated stand secured at one end to a base and a pivoting support at another end. The pivoting support includes a clamp for receiving a fishing rod at a variable location. The fishing rod is maintained in an inclined orientation when baited, and pivots to a declined orientation in response to receiving a fish on its line. The pivoting support and fishing rod may be disengaged from to stand after receiving a fish on the line to set the hook and reel in the fish.

### CROSS-REFERENCE TO RELATED APPLICATIONS

This application claims priority from previously filed U.S. Provisional Patent Application Ser. No. 61/563,136 filed on Nov. 23, 2011 hereby incorporated by reference in its entirety.

### BACKGROUND OF THE INVENTION

1. Field of the Invention

The present invention relates generally to a device for use in ice fishing, and more specifically to a folding device for use in supporting an ice fishing rod in a pivoting inclined orientation.

2. Discussion of the Related Art

There are many types of ice fishing devices that have been developed for supporting an ice fishing rod. Some of these devices eliminate the need for a fisherman to physically hold the fishing rod while waiting for a fish to strike the line. Others include a signaling apparatus to alert a fisherman to movement on the fishing line.

However, many of these devices decrease the probability of catching fish, because their mechanics add noticeable resistance to the line. For example, some devices include spring loaded flags, which are elevated in response to a fish taking a bated hook. However, the added force required to release the spring loaded flag mechanism is often enough to prevent the fish from fully taking the baited hook. Other devices, commonly referred to as tip downs have attempted to reduce this resistance by using the pivoting movement of the fishing rod as the strike indicator. That is to say, a relatively light inclined fishing rod will simply pivot into a declined orientation once the fish has taken the baited hook. However, many of these devices require the use of a custom rod, having an integrated or fixed pivoting point and a lightweight reel device. This fixed pivoting point can make the rod difficult to set in the inclined position based on the amount and weight of line that is located on the reel spool. Also, the lightweight reels that are often integrated into these tip downs sacrifice functionality and efficiency in order to maintain a decreased weight.

Resultantly, it is desirable to develop a pivoting ice fishing rod support that provides the ability to signal a strike without adding substantial resistance to the fishing line, while simultaneously maintaining the convenience and functionality of a modern ice fishing rod and reel. Furthermore, it is desirable that the rod may be easily removed from the support after a fish has taken the bait, so that the hook may be set and the fish reeled in. It is also desirable that such an ice fishing rod support is both light and compact and easily transported to and from the fishing site.

### SUMMARY OF THE INVENTION

In accordance with a first aspect of the invention, a pivoting ice fishing rod support is provided for use in signaling when a fish has taken a baited hook while limiting the amount of resistance on the fishing line. The device includes a stand that is configured to support a fishing pole above the surface of the ice. When the hook is baited and awaiting a fish, the fishing pole is oriented at an inclined angle, with the tip of the pole higher than the end, or handle of the pole. The fishing pole is connected to the stand by way of a pivoting support, which may be attached to a fishing pole at any location along the length of the pole, as to adjust the balance and inclined angle of the pole. When a fish engages the hook, the tip of the pole drops into a declined orientation, which both signals that a fish has taken a baited hook and limits the amount of resistance on the fishing line.

In another aspect of the present invention, the pivoting support may be disengaged from the stand by lifting the rod, thereby disengaging a pivot pin from a notch in the upper end of the stand.

In accordance with yet another aspect of the invention, the stand may be pivotably affixed to the base such that the stand and base may be folded into a generally coplanar storage or transport configuration and unfolded into a raised configuration wherein the stand is oriented substantially perpendicular to the base.

Numerous other aspects, features, and advantages of the present invention will be made apparent from the following detailed description together with the drawings figures.

### BRIEF DESCRIPTION OF THE DRAWINGS

The drawings illustrate the best mode currently contemplated of practicing the present disclosure.

In the drawings:

FIG. 1 is a left side perspective view of one embodiment of the pivoting ice fishing rod support device according to the present disclosure in a raised configuration with the fishing rod in an inclined orientation;

FIG. 2 is a left side perspective view of the device of FIG. 1, with the fishing rod in an declined orientation; and

FIG. 3 is a top plan view of the device of FIG. 1 in a folded configuration.

### DETAILED DESCRIPTION OF THE INVENTION

I. The Apparatus

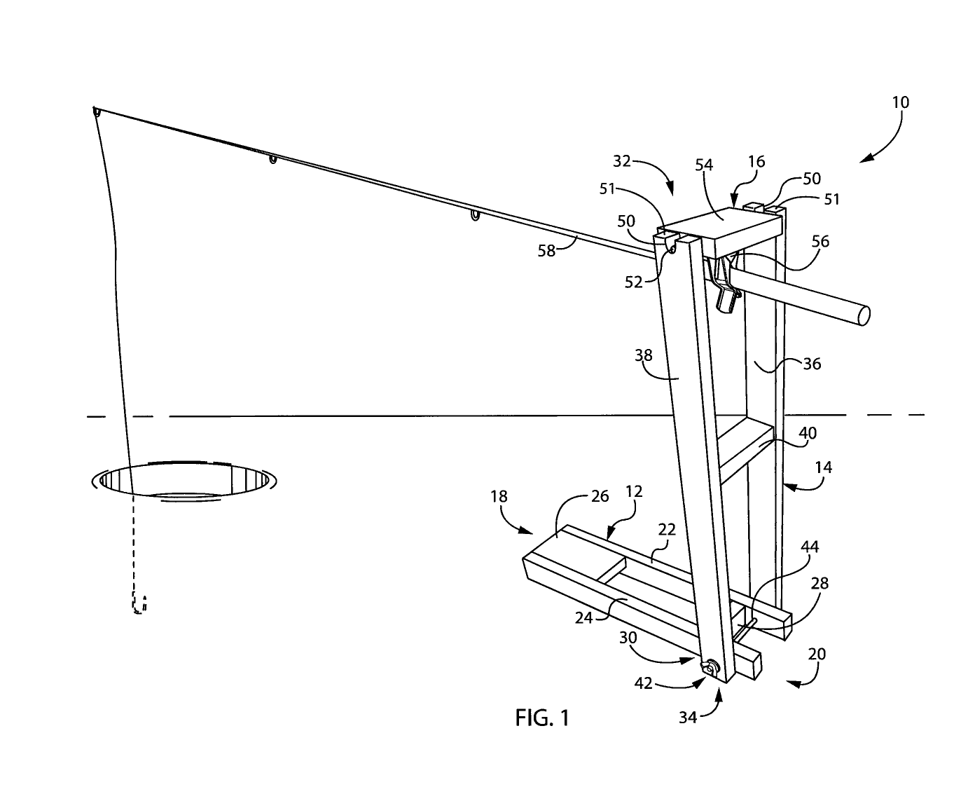

Referring now in detail to the drawing figures, wherein like reference numerals represent like parts throughout the several views, one embodiment of a device constructed according to the present disclosure is illustrated generally at 10 in FIG. 1. The device 10 in the illustrated embodiment is formed of a base 12, a stand 14 and a pivoting support, i.e., cradle 16. The base 12, stand 14 and cradle 16 can be formed of any suitable material, such as a metal, plastic or wood capable of enabling the device 10 to perform in its intended manner. Additionally, the base 12, stand 14 and cradle 16 can have any desired axial and/or cross-sectional shape suitable for the intended purpose of the device 10, and are not so limited to the embodiments illustrated in drawing figures.

The base 12 includes a first end 18 and a second end 20. As seen in FIGS. 1-3, the base 12 may be formed of a first leg 22 and a second leg 24. A first base brace 26 and a second base brace 28 may be disposed between the first and second legs 22, 24 of the base 12. The first base brace 26 may be located at the first end 14 of the base 12, and may also have a side congruent with the first end 14. The second base brace 28 may be located a position distant from the first base brace 26, nearer the second end 20 of the base 12, as seen in FIG. 1. In one embodiment, an aperture 30 may be located within both the first and second legs 22, 24, in alignment with one another and positioned between the second base brace 28 and the second end 20 of the base. The legs 22, 24 and braces 26, 28 may be connected together by adhesive, fasteners, dovetail joints or any other commonly known fastening means. Alternatively, the legs 22, 24 and braces 26, 28 may not be discrete elements, but rather formed of a single piece of material. Furthermore, the size, shape and orientation of the braces 26, 28 may vary in as much as the base 12 is capable of enabling the device 10 to function in its intended manner.

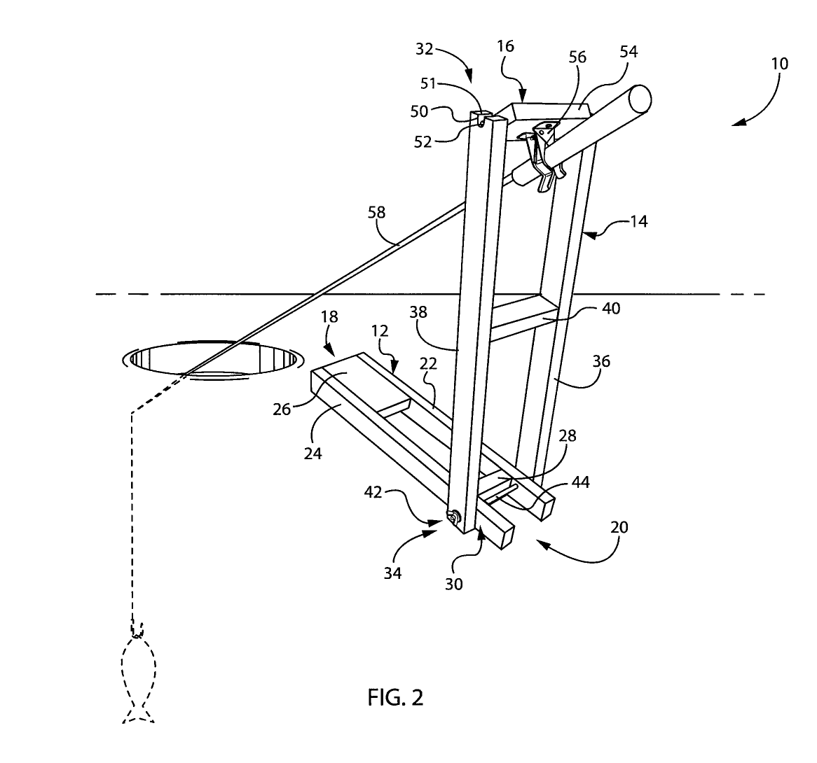

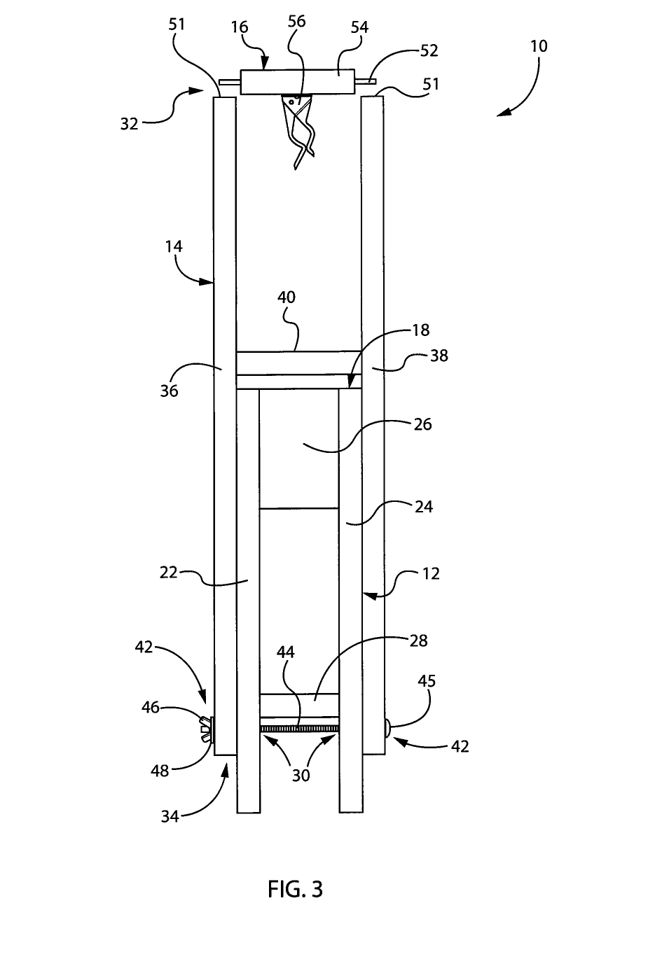

Still referring to FIG. 1, the stand 14 includes a first end 32 and a second end 34. The stand 14 may be formed of a first arm 36 and a second arm 38. To maintain their alignment, a stand brace 40 may be disposed between the first and second arms 36, 38 of the stand 14. The stand brace 40 may be located between the first end 32 and second end 34 of the arms 36, 38. In one embodiment, the stand brace 40 is located at a position along the stand arm, such that it does not impede or disrupt the motion of the fishing rod as illustrated in FIGS. 2 and 3. In this embodiment, the stand brace 40 is furthermore located at a sufficient distance from the second end 34 to be spaced beyond the first end 18 of the base 12 as to allow the device 10 to be configured in a folded configuration as illustrated in FIG. 3. The arms 36, 38 and stand brace 40 may be connected together by adhesive, fasteners, dovetail joints or any other commonly known fastening means.

Furthermore, the surfaces of the arms 36, 38, or other portions of the device 10 may include an increased visibility surface application, such as high visibility paint or reflective tape. This increased visibility surface application will aid in revealing the location of the device 10 to others from a greater distance, as well as in low light environments and/or inclement weather.

As illustrated in FIG. 3, one aperture 42 is located in each of the arms 36, 38 in alignment with one another and adjacent the second end 34 of the stand 14. The apertures 42 of the first and second arms 36, 38 are configured to be positioned coaxial with the apertures 30 of the first and second legs 22, 24, such that an anchoring member 44, such as a bolt having a head 45, may be received therein. The bolt 44 is threaded through the four apertures 30, 42, and secured in that position by a fastener 46 engaged with the bolt 44 opposite the head 45. The fastener 46 may be a nut, such as a wing nut, and may also employ one or more washers 48 placed on the bolt shaft prior to engaging the fastener 46. As will be discussed in further detail below, the anchoring mechanism 44 allows the base 12 and the stand 14 to pivot or rotate relative to one another about the longitudinal axis of the anchoring member 44, such that the device 10 may be folded into a substantially coplanar orientation and also raised into a substantially perpendicular orientation. The apertures 42 of the arms 36, 38 are located at a distance from the second end 34 such that when the device 10 is in a raised configuration, the second end 34 of the stand 14 does not project beyond the arms 22,24 of the base 12, allowing the base 12 to rest flat along a support surface, e.g., ice.

Generally opposite the aperture 34, near the first end 32 of each arm 36, 38 is a notch 50. In the illustrated embodiment, the notched 50 are located in the upper surfaces 51 of the arms 36, 38, but could be located on either side of each arm 36, 38 adjacent the upper surface 51. Further, in the illustrated embodiment, the notches 50 are open ended and are utilized without any locking mechanism to retain the cradle 16 within the notches 50, though one could be utilized in alternative embodiments. The notches 50 are configured to receive pivot pins 52 on the cradle 16, and support the cradle 16 between the first and second arms 36, 38, as discussed in detail below.

Turning now to FIGS. 1-3, the cradle 16 includes the pair of pivot pins 52, a support block 54, and a clamp 56. The support block 54 is configured to be suspended between the first and second arms 36, 38 of the stand 14, when the device 10 is in the raised configuration. Specifically, in the embodiment illustrated in FIG. 3 the pair of pivot pins 52 protrude from a centrally located position on either side of the support block 54. Alternatively, a single elongated pivot pin 52 may extend throughout the entire support block 54, such that it also protrudes from each side. The protruding or exposed length of the pivot pins 52 is configured to be received partially within the notches of the first and second arms 36, 38 of the stand 14, as described above. In such a configuration, the support block 54 will be rotatably suspended between the arms 36, 38 at the first end 32 by the engagement of the pins 52 within the notches 50 with a lower face of the support block 54 directed downwards towards the base 12.

A clamp 56 is secured to the lower face, or bottom of the support block 54, as illustrated in FIGS. 1 and 2. The clamp 56 is configured to releasably retain an ice fishing rod 58 therein, and may comprise a spring loaded clamp, a threaded clamp, or any alternative form of releasably retaining the ice fishing rod 58 to the lower face of the support block 54. The clamp 56 may be configured to receive the fishing rod 56 at any variable location along the length of the rod 58, thereby allowing the fisherman to manipulate the desired balance and orientation of the fishing rod 58 and block 54 relative to the remainder of the device 10. As the cradle 16 simply rests within the notches 50 of the stand 14, it can be easily lifted off of the stand, as to allow the fisherman to operate the fishing rod 58 and reel (not shown) independent of the base 12 and stand 14.

II. In Use

In operation, the device 10 may be transported to the fishing site in a folded configuration, as illustrated in FIG. 3 to facilitate ease of transportation. At the desired location, the device 10 may be unfolded into the raised configuration by rotating the stand 14 relative the base 12 about the anchoring member 44, until the stand 14 is nearly perpendicular to the base 12. This can be facilitated by loosening the fastener 46 prior to rotating the stand 14 relative to the base 12, and subsequently retightening the fastener 46 at the desired configuration for the stand 14 relative to the base 12. Of course, it is also possible to operate device 10 at different respective angles between the base 12 and stand 14, or for the base 12 and a stand 14 to remain in a fixed position relative to one another.

Once raised, the fishing rod 58 is secured to the cradle 16, via the clamp 56. As seen in FIG. 1, the cradle 16 is located such that it does not interfere with the motion of the reel (not shown), when in use. After the fishing hook has been baited, and placed within the ice fishing hole, the cradle 16 is placed on top of the stand 14, such that the pivot pins 52 engage and rest within the notches 50 in the arms 36, 38 of the stand 14, as seen in FIG. 1. The rod 58 and cradle 16 may be positioned on the stand 14 such that the rod 58 can extend either in a forward orientation or a backwards orientation relative to the stand 14. As previously discussed, the balance of the rod 58 may be adjusted by altering both the location of the clamp 56 on the rod and/or the location of the reel (not shown) on the rod 58.

Still referring to FIG. 1, the cradle 16 is initially oriented at an inclined angle relative to the base 12. By way to the fishing rod 58 being secured to the cradle 16, the fishing rod 58 is also initially oriented at an inclined angle relative to the base 12, such that the tip of the rod 58 is elevated relative to the reel end of the rod 58. In one embodiment, the angle of incline is approximately 45 degrees, however, the angle may be adjusted as desired by the fisherman by adjusting the position of the rod 58 within the clamp 56. Once a fish has engaged or taken the baited hook, the rod 58 and cradle 16 will pivot around the longitudinal axis of the pivot pins 52 such that the cradle 16 and fishing rod 58 pivot into a second orientation with a declined angle relative to base 12, as seen in FIG. 2. This orientation change from inclined to declined angle will signal to the fisherman that a fish has engaged or taken the baited hook. At which point the fisherman may grasp and firmly raise the rod 58 and cradle 16 off of the stand 14 to set the hook securely within the fish. With the rod 58 in hand, the fisherman may now either operate the reel or further lift the rod 58 to pull the fish from out of the ice fishing hole. If per chance, the hook is not securely set when the rod 58 is lifted and the fish escapes, the rod 58 and cradle 16 may be quickly replaced on the stand 14, with the pivot pins 52 in the notches 50, at the initially oriented inclined angle without need for significant adjustment.

Due to the ability to adjust the location of the clamp 56 about the rod 58, and the reel about the rod 58, it is possible for the fisherman to obtain the desired inclined angle when fishing at any depth, or with any weight of fishing line without the need to counterbalance the rod 58. Resultantly, the proper angle, and lack of additional counterweight will result in a diminished amount of additional resistance added to the fishing line, thereby allowing both small pan fish as well as larger fish, i.e. perch or walleye, to be caught using device 10.

Various other embodiments of the present invention are contemplated as being within the scope of the filed claims particularly pointing out and distinctly claiming the subject matter regarded as the invention.

1. An ice fishing device comprising:
a stand having a first end and a second end;
a base connected to the stand at the second end; and
a pivoting support selectively connected to the stand generally opposite the second end, wherein the pivoting support is configured to be releasably coupled to a fishing rod.

2. The device of claim 1 wherein the pivoting support further comprises a pivot pin configured to be received within a pair of notches generally opposite the second end of the stand, and the pivoting support is pivotable between:
a first orientation wherein the pivoting support has a first angle relative to the base; and
a second orientation wherein the pivoting support has a second angle relative to the base, the second angle being different than the first angle.

3. The device of claim 2, wherein the pivot pin is selectively disengagable from the pair of notches.

4. The device of claim 3, wherein the pivoting support is configured to be coupled to the fishing rod.

5. The device of claim 4, wherein the pivoting support is configured to be coupled to the fishing rod at a variable location along a length of the fishing rod.

6. The device of claim 4, wherein the pivoting support is configured to be coupled to the fishing rod when the pivoting support is selectively disengaged from the stand.

7. The device of claim 1, having an anchoring member connecting the stand and base at the second end.

8. The device of claim 7, wherein the stand is pivotably mounted to the base about the anchoring member.

9. The device of claim 8, having a folded configuration wherein the stand and base are substantially coplanar, and a raised configuration.

10. The device of claim 9 in the raised configuration, wherein the pivoting support further comprises a pivot pin configured to be received within a pair of notches generally opposite the second end of the stand, and the pivoting support is pivotable between:
a first orientation wherein the pivoting support has a first angle relative to the base; and
a second orientation wherein the pivoting support has a second angle relative to the base, the second angle being different than the first angle.

11. An ice fishing device comprising:
a stand having a first end and a second end, the stand including a pair of notches generally opposite the second end;
a base receiving the stand at the second end;
an anchoring member pivotably affixing the stand to the base at the second end;
a pivoting support disposed on the stand and including:
a pivot pin selectively received within the pair of notches, and
a clamp operably connected to the pivot pin and adapted to receive a fishing rod; and
wherein and the pivoting support is pivotable between:
a first orientation wherein the pivoting support has a first angle relative to the base; and
a second orientation wherein the pivoting support has a second angle relative to the base, the second angle being directionally opposed the first.

12. The device of claim 11, wherein the clamp is adapted to receive the fishing rod at a variable location along a length of the fishing rod.

13. The device of claim 11, having a folded configuration wherein the stand and base are substantially coplanar, and a raised configuration.

14. A method of detecting motion of an ice fishing pole having minimal resistance, comprising the steps of:
providing an ice fishing device, comprising:
a stand having a first end and a second end,
a base connected to the stand at the second end, and
a pivoting support selectively connected to the stand generally opposite the second end, wherein the pivoting support is configured to be releasably coupled to a fishing rod;
securing the pivot support to a fishing rod;
balancing the pivot support within the pair of notches generally opposite the second end of the stand in an a first orientation wherein the pivoting support has a first angle relative to the base to maintain minimal resistance on a fishing line extending from the rod; and
lifting the rod to disengage balancing the pivot support and fishing rod from within the pair of notches in response to movement of the pivot support and fishing rod to a second orientation wherein the pivoting support has a second angle relative to the base, the second angle being different than the first angle.

15. The method of claim 14, wherein the step of providing an ice fishing device further comprises the step of:
elevating the ice fishing device from a folded configuration wherein stand and base are substantially coplanar, to a raised configuration wherein the stand is oriented at and angle with respect to the base.

16. The method of claim 14, wherein the step of securing the pivot support further comprises the step of:
securing the pivot support to the fishing rod to a variable location along the length of the fishing pole.

17. The method of claim 14, further comprising the step of:
extending the fishing line from the rod into an ice fishing hole prior to balancing the pivot support.

18. The method of claim 14, wherein the first angle is an inclined angle configured to maintain a tip of the fishing rod above an end of the fishing rod when a fish has not engaged a hook extending from the tip; and the second angle is a declined angle configured to maintain a tip of the fishing rod below the end of the fishing rod when the fish has engaged the hook extending from the tip.

19. The method of claim 14, wherein the step of lifting the fishing rod further comprises the step of:
maintaining the fishing rod secured to the pivot support while lifting the fishing rod.

20. The method of claim 14, further comprising the step of:
lowering the rod to reengage balancing the pivot support within the pair of notches generally opposite the second end of the stand in the first orientation.
